(19) United States
(12) Patent Application Publication
(10) Pub. No.: US 2005/0090769 A1
(43) Pub. Date: Apr. 28, 2005

(54) Leg massaging device

(76) Inventor: Ko-Po Chen, Ta-Li City (TW)

Correspondence Address: LAW OFFICE OF LIAUH & ASSOC., 4224 WAIALAE AVE, STE 5-388, HONOLULU, HI, 96816, US

(21) Appl. No.: 10/694,702

(22) Filed: Oct. 22, 2003

(51) Int. Cl. A61H 15/00

(52) U.S. Cl. 601/99; 601/100; 601/102; 601/118; 601/121; 601/127

(57) ABSTRACT

A leg massaging device comprises an outer frame which is provided with a reciprocating displacement mechanism. The reciprocating displacement mechanism is provided in an inner frame with a massaging roller, and a drive shaft which is connected at both ends to the outer frame by a transmission set. The drive shaft is driven by a motor to actuate the massaging roller to engage in a reciprocating motion, so as to enhance the massaging effect of the leg massaging device.

### FIELD OF THE INVENTION

The present invention relates to a leg massaging device which can be used as an independent device or incorporated into a massaging chair.

### BACKGROUND OF THE INVENTION

As shown in FIGS. 1 and 2, a massaging chair 1 of the prior art comprises a seat 2 and a leg massaging device 3 comprising a frame 4 and two mounting seats 5 for mounting thereon a drive motor 6. A massaging roller 7 is driven by the motor 6 to bring about a leg massaging effect. The prior art massaging device 3 is defective in design in that the massaging roller 7 is incapable of massaging an entire leg.

As shown in FIG. 4, a portable massaging device of the prior art comprises a frame 8 on which two massaging rollers 10 are mounted by means of a shaft 9 such that the massaging rollers 10 are actuated by a gear set 12 driven by a motor 11. The leg massaging effect is brought about by placing the leg of a user of the massaging device on the massaging rollers 10, as illustrated in FIG. 5. This prior art massaging device is also defective in design in that the massaging rollers 10 of the device are incapable of massaging an entire leg.

### SUMMARY OF THE INVENTION

The primary objective of the present invention is to provide a leg massaging device free of the shortcoming of the prior art massaging devices described above.

In keeping with the principle of the present invention, the foregoing objective of the present invention is attained by a leg massaging device comprising an outer frame and an inner frame. The outer frame is used to mount a massaging roller, whereas the inner frame is used to mount a reciprocating displacement mechanism enabling the massaging roller to move in a reciprocating manner so as to bring about a massaging effect on an entire leg.

The features and the advantages of the present invention will be more readily understood upon a thoughtful deliberation of the following detailed description of the present invention with reference to the accompanying drawings.

### BRIEF DESCRIPTION OF THE DRAWINGS

FIG. 1 shows a perspective view of an electric massaging chair of the prior art.

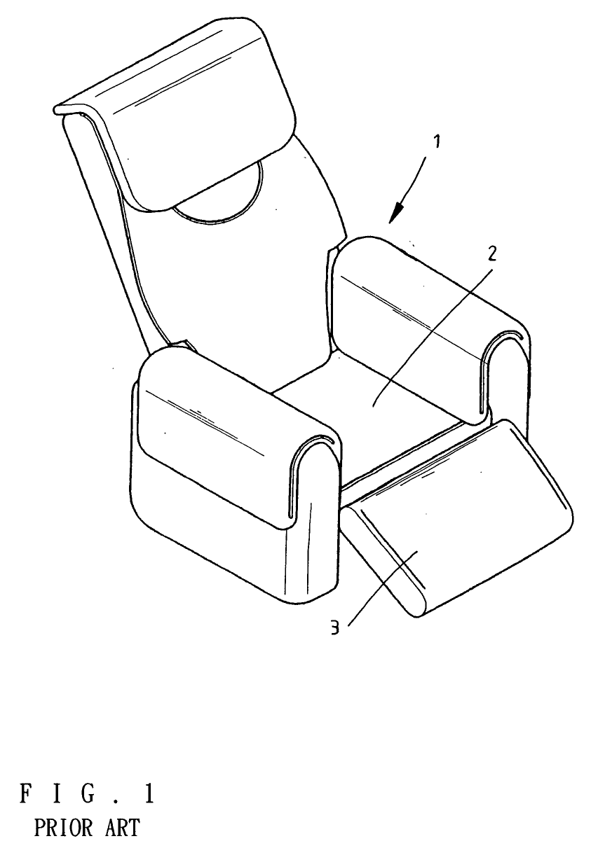

FIG. 2 shows a schematic view of a leg massaging device of the prior art electric massaging chair.

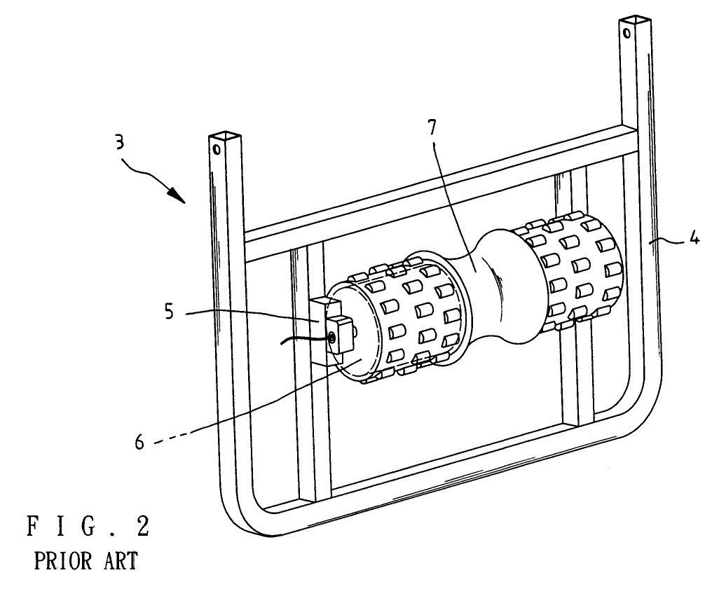

FIG. 3 shows a schematic view of the prior art leg massaging device at work.

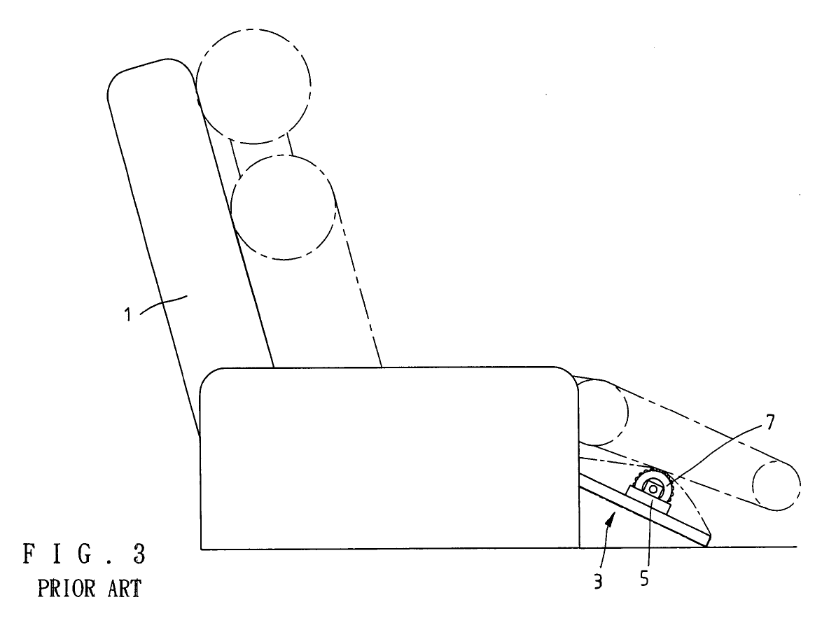

FIG. 4 shows a schematic view of a portable massaging device of the prior art.

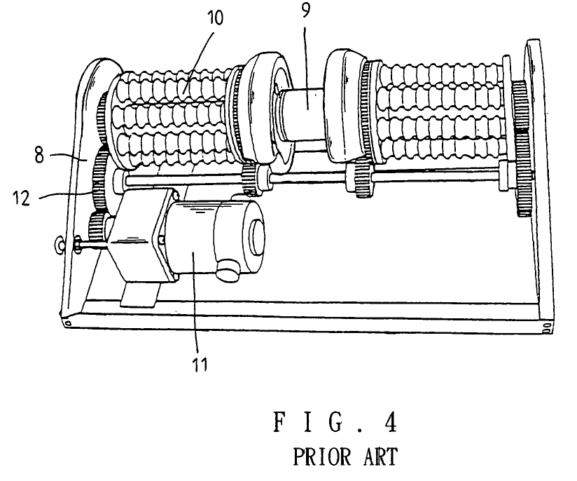

FIG. 5 shows a schematic view of the prior art portable massaging device at work.

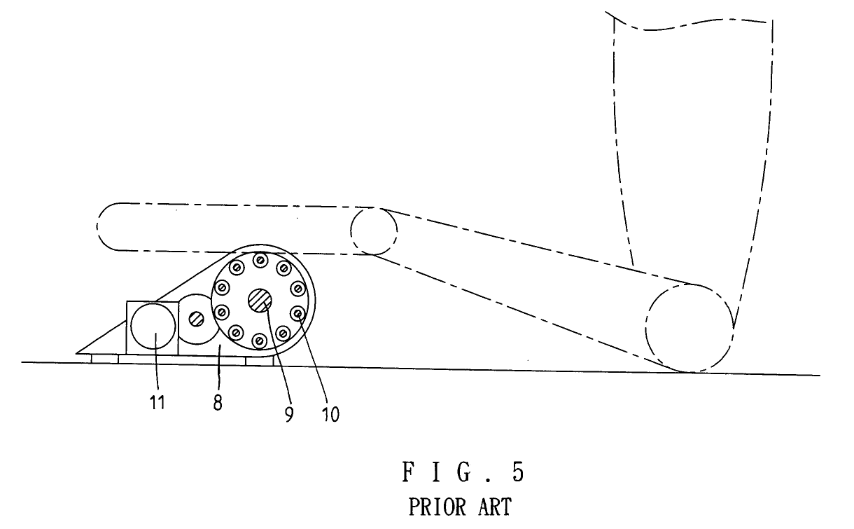

FIG. 6 shows a schematic view of the present invention.

FIG. 7 shows a front view of the present invention.

FIG. 8 shows a schematic view of displacement of the massaging roller of the present invention.

FIG. 9 shows another schematic view of displacement of the massaging roller of the present invention.

FIG. 10 shows a schematic view of the present invention working as an independent massaging machine.

FIG. 11 shows a schematic view of the present invention at work as an independent massaging machine.

FIG. 12 shows another schematic view of the present invention at work as an independent massaging machine.

FIG. 13 shows a schematic view of the present invention which is incorporated into an electric massaging chair.

FIG. 14 shows a schematic view of the working of the present invention as shown in FIG. 13.

FIG. 15 shows another schematic view of the working of the present invention as shown in FIG. 13.

### DETAILED DESCRIPTION OF THE INVENTION

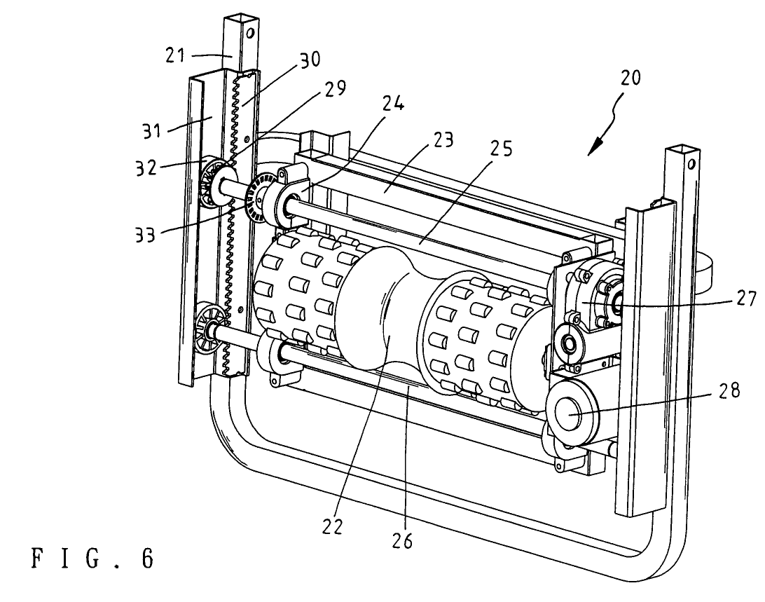

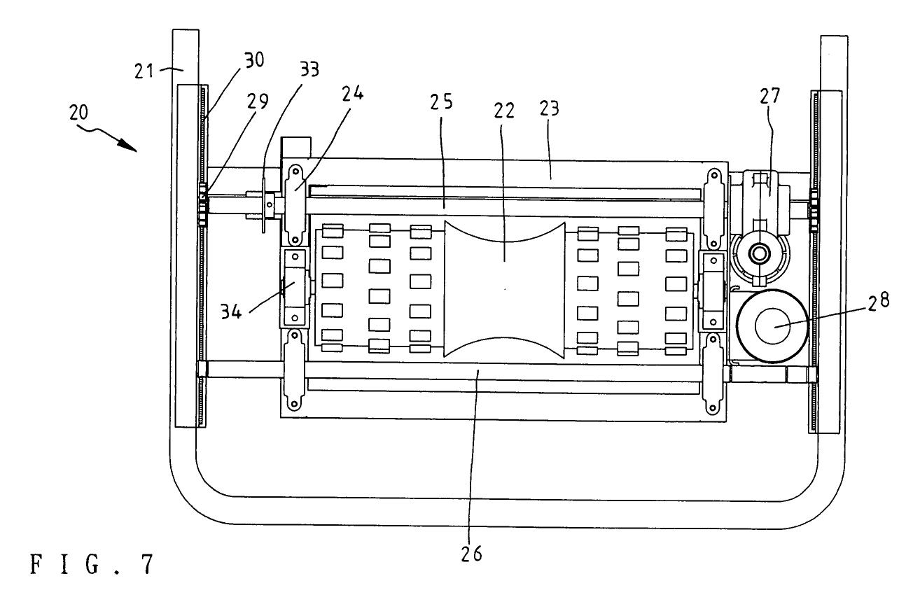

As shown in FIGS. 6 and 7, a massaging device 20 embodied in the present invention comprises an outer frame 21 in which a massaging 22 and a reciprocating displacement mechanism are mounted. The reciprocating displacement mechanism comprises an inner frame 23 on which a drive shaft 25 and a driven shaft 26 are mounted in conjunction with a bearing seat 24. The drive shaft 25 is connected at one end with a variable speed mechanism 27 and a motor 28 serving as a driving source. A transmission set is mounted on the outer frame 21. The drive shaft 25 is provided with a gear 29 which is engaged with a rack 30 mounted on the outer frame 21. The outer frame 21 is provided in two sides with a slide slot frame 31 for mounting rollers 32 which are respectively mounted at one end of the drive shaft 25 and the driven shaft 26. The drive shaft 25 is provided with a sensor blocking piece 33 for controlling the displacement. The inner frame 23 is provided with a massaging roller 22 mounted thereon by a seat 34. The massaging roller 22 is provided therein with a driving source.

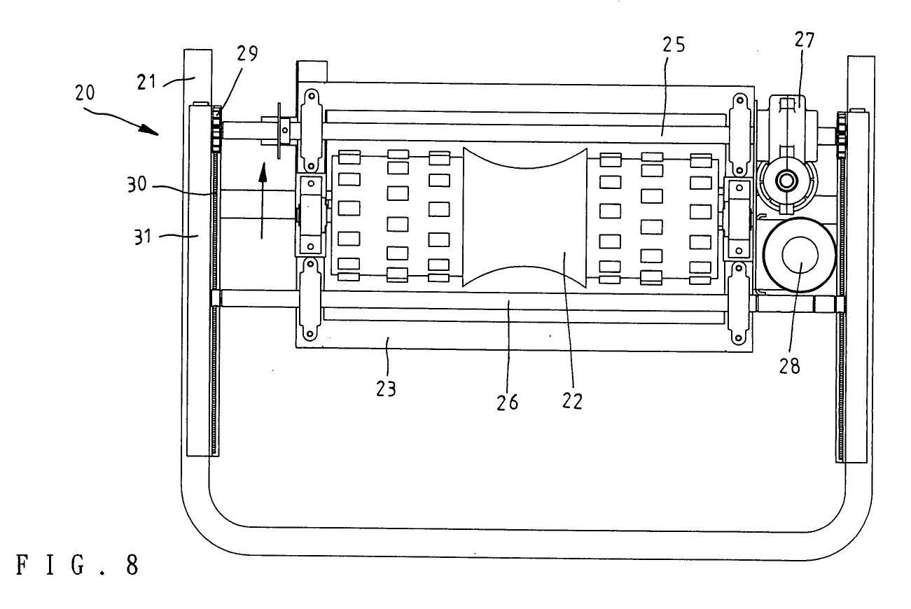

As shown in FIGS. 6-8, the drive shaft 25 is driven by the motor 28 via the variable speed mechanism 27, thereby causing the gears 29 of both ends of the drive shaft 25 to move upward along the rack 30 of the outer frame 21. As a result, the inner frame 23 is caused to displace. Meanwhile, the rollers 32 of the drive shaft 25 and the driven shaft 26 slide in the slide slot frame 31 of the outer frame 21, so as to actuate the massaging roller 22 of the inner frame 23 to displace upward along the outer frame 21.

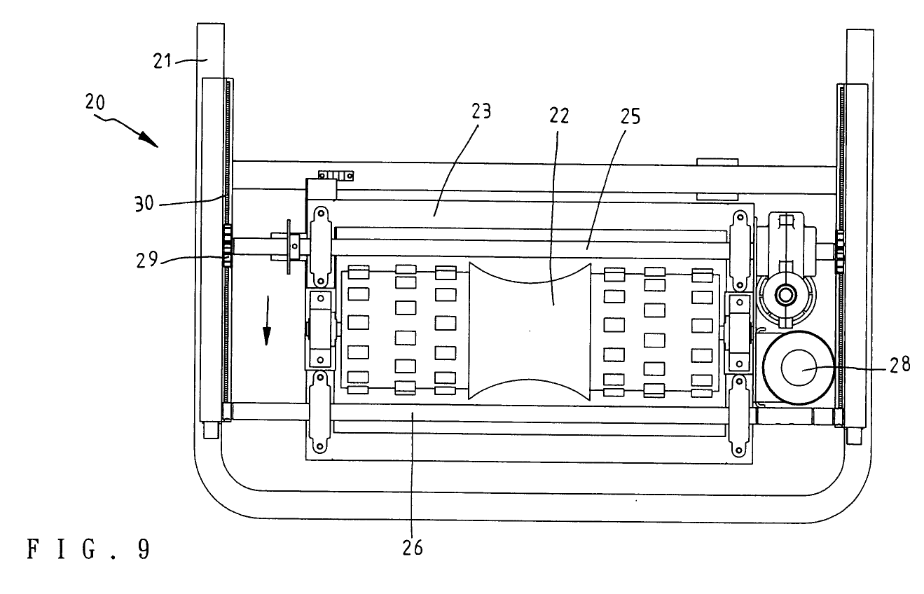

As shown in FIG. 9, when the drive shaft 25 is driven by the motor 28 to turn in reverse, the gear 29 of the drive shaft 25 moves downward along the rack 30. As a result, the inner frame 23 and the driven shaft 26 are caused to displace, thereby resulting in a downward displacement of the massaging roller 22 in the outer frame 21. The massaging roller 22 is therefore capable of a reciprocating motion.

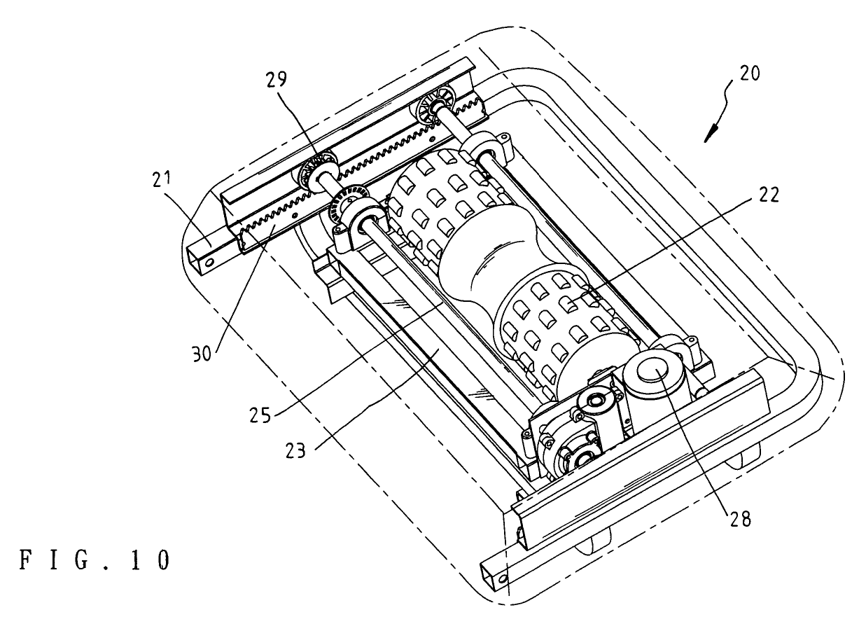

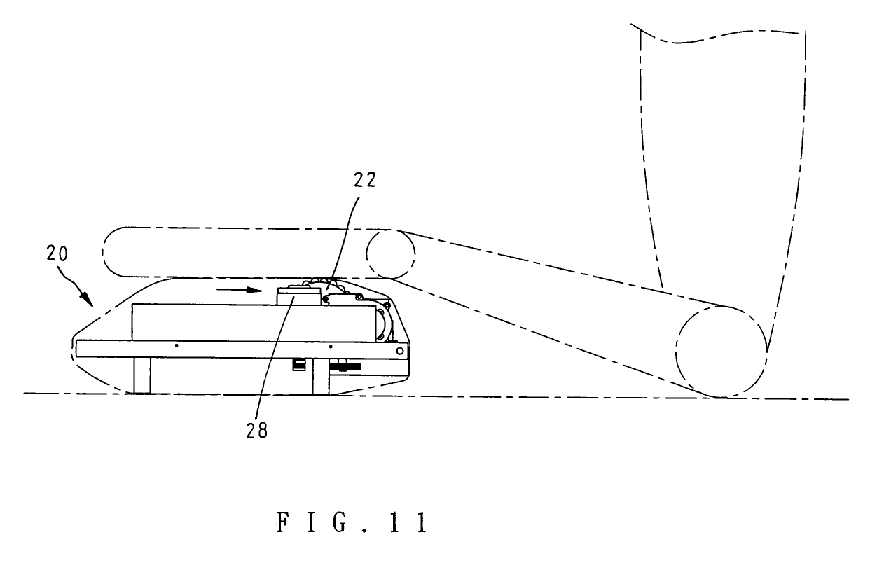

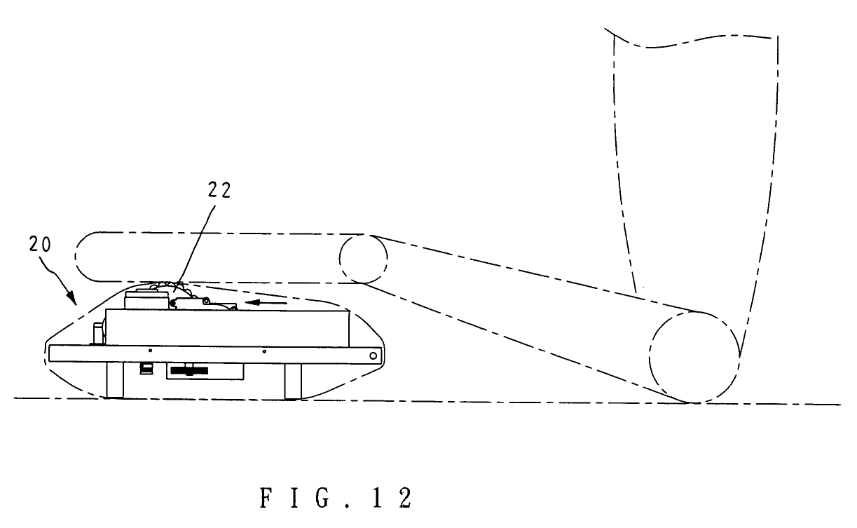

As shown in FIGS. 10-12, the massaging device 20 of the present invention is used as an independent massaging machine on which both legs of a machine user are properly located. The massaging roller 22 is capable of a self-rotation. As the drive shaft 25 is driven by the motor 28 to turn, the massaging roller 22 is actuated to engage in a reciprocating motion along the legs of the machine user. The massaging effect of the massaging roller 22 is not therefore confined to a specific area of the legs of the machine user.

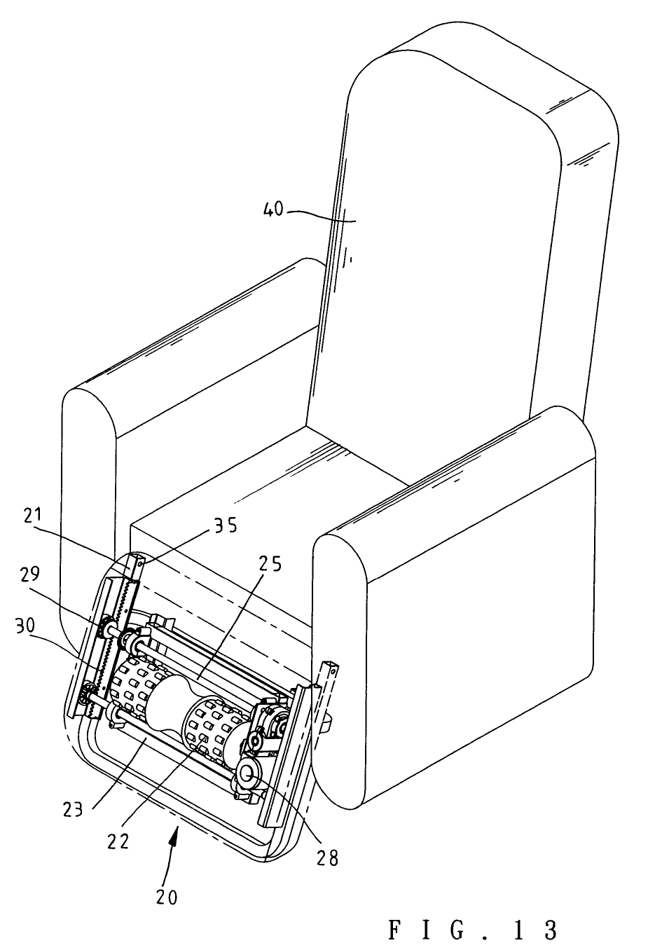

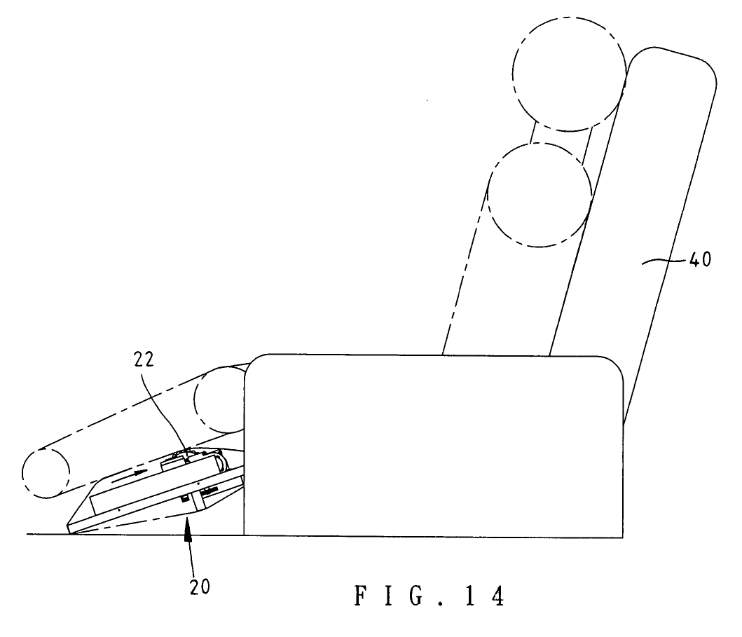

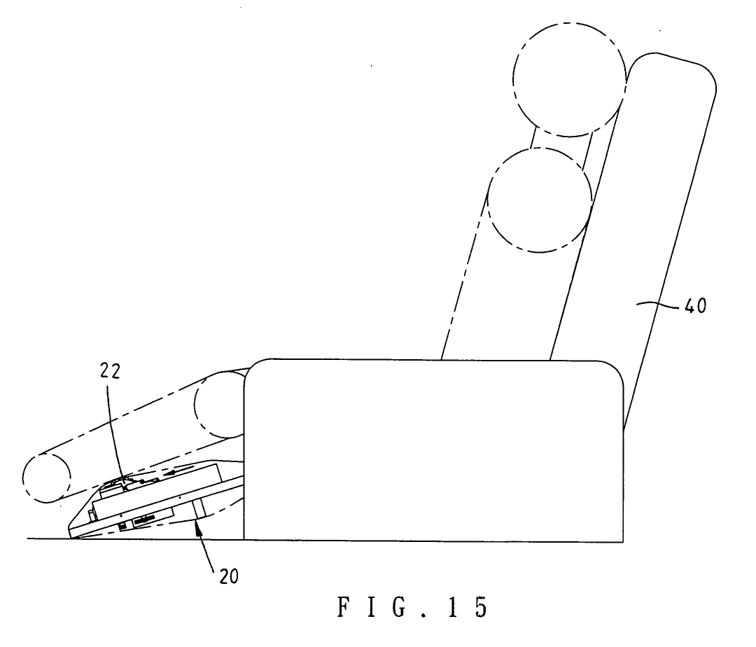

As shown in FIGS. 13-15, the massaging device 20 of the present invention is incorporated into an electric massaging chair 40. The outer frame 21 is provided with a plurality of pivoting holes 35 by which the massaging device 20 is pivotally fastened to a frame of the electric massaging chair 40. In operation, the drive shaft 25 is driven to turn by the motor 28. In light of the gears 29 of both ends of the drive shaft 25 being engaged with the rack 30 mounted on the outer frame 21, the massaging roller 22 of the inner frame 23 is actuated to engage in a reciprocating motion along the legs of a user of the electric massaging chair 40. The massaging effect of the massaging device 20 of the present invention is therefore not confined to a specific area of the legs of the user of the electric massaging chair 40.

The present invention described above is to be regarded in all respects as being illustrative and nonrestrictive. Accordingly, the present invention may be embodied in other specific forms without deviating from the spirit thereof. The present invention is therefore to be limited only by the scopes of the following claims.

1. A leg massaging device comprising an outer frame which is provided with a reciprocating displacement mechanism whereby the reciprocating displacement mechanism comprises an inner frame for mounting a massaging roller such that the massaging roller is actuated to engage in a reciprocating motion on the outer frame.

2. The leg massaging device as defined in claim 1, wherein the inner frame is provided with a bearing seat for mounting a drive shaft whereby the drive shaft is connected at one end to a drive source and is provided with a transmission set.

3. The leg massaging device as defined in claim 2, wherein the inner frame of the reciprocating displacement mechanism is provided with a bearing seat for mounting a driven shaft.

4. The leg massaging device as defined in claim 3, wherein the driven shaft is provided at two ends with a roller whereby the roller is slidably disposed in a slide slot frame of the outer frame.

5. The leg massaging device as defined in claim 2, wherein the drive source of the reciprocating displacement mechanism is a motor whereby the motor serves to drive the drive shaft via a variable speed mechanism.

6. The leg massaging device as defined in claim 2, wherein the transmission set of the reciprocating displacement mechanism comprises two gears which are respectively mounted on two ends of the drive shaft such that the two gears are engaged with a rack mounted on the outer frame.

7. The leg massaging device as defined in claim 2, wherein the drive shaft is provided at two ends with a roller whereby the roller is slidably disposed in a slide slot frame of the outer frame.

8. The leg massaging device as defined in claim 2, wherein the drive shaft of the reciprocating displacement mechanism is provided with a sensor blocking piece.

9. A leg massaging device incorporated into a chair and provided in an outer frame thereof with a reciprocating displacement mechanism whereby the reciprocating displacement mechanism comprises an inner frame, and a massaging roller mounted on the inner frame such that the massaging roller is actuated to engage in a reciprocating motion on the outer frame.

10. The leg massaging device as defined in claim 9, wherein the inner frame is provided with a bearing seat for mounting a drive shaft whereby the drive shaft is connected at one end to a drive source and is provided with a transmission set.

11. The leg massaging device as defined in claim 10, wherein the inner frame of the reciprocating displacement mechanism is provided with a bearing seat for mounting a driven shaft.

12. The leg massaging device as defined in claim 11, wherein the driven shaft is provided at two ends with a roller whereby the roller is slidably disposed in a slide slot frame of the outer frame.

13. The leg massaging device as defined in claim 10, wherein the drive source of the reciprocating displacement mechanism is a motor whereby the motor drives the drive shaft to turn via a variable speed mechanism.

14. The leg massaging device as defined in claim 10, the transmission set of the reciprocating displacement mechanism comprises two gears which are respectively mounted on two ends of the drive shaft such that the two gears are engaged with a rack mounted on the outer frame.

15. The leg massaging device as defined in claim 10, wherein the drive shaft and the driven shaft are provided at two ends with a roller whereby the roller is slidably disposed in a slide slot frame of the outer frame.

16. The leg massaging device as defined in claim 10, wherein the outer frame of the reciprocating displacement mechanism is provided with a plurality of pivoting holes for fastening pivotally the outer frame with a frame of the chair.
